(19) United States
(12) Patent Application Publication
(10) Pub. No.: US 2026/0187530 A1
(43) Pub. Date: Jul. 2, 2026

(54) METHOD AND APPARATUS FOR DETECTING ANOMALY BASED ON TIME INFORMATION, ELECTRONIC DEVICE AND MEDIUM

(71) Applicant: SKSPRUCE TECHNOLOGIES CO., LTD., Chengdu (CN)

(72) Inventors: Yee SOON, Chengdu (CN); Yongcheng LEI, Chengdu (CN); Fang WU, Chengdu (CN); Siyuan WANG, Chengdu (CN)

(21) Appl. No.: 19/430,780

(22) Filed: Dec. 23, 2025

(30) Foreign Application Priority Data
Dec. 29, 2024 (CN) 202411956851.3

(51) Int. Cl. G06N 20/00

(52) U.S. Cl. CPC G06N 20/00

(57) ABSTRACT

A method and an apparatus for detecting an anomaly based on time information, an electronic device and a medium. The method includes: dividing a preset detection period into multiple preset time intervals; performing different anomaly detection operations on log lines generated by a target system during each of the multiple preset time intervals to obtain anomaly scores of different detection types corresponding to the preset time interval; adding preset detection type tokens to discrete anomaly scores to obtain marker token data, and adding a preset timestamp token to a timestamp corresponding to the preset time interval to obtain timestamp token data; and combining the timestamp token data and the marker token data to form a token sequence, performing anomaly detection on the token sequence by using a pre-trained detection model to determine whether the target system is anomalous.

### CROSS REFERENCE TO RELATED APPLICATIONS

The present invention claims priority under 35 U.S.C. § 119 to Chinese Patent Application No. 202411956851.3, titled “METHOD AND APPARATUS FOR DETECTING ANOMALY BASED ON TIME INFORMATION, ELECTRONIC DEVICE AND MEDIUM”, filed on Dec. 29, 2024, with the China National Intellectual Property Administration, the entire contents of which being incorporated herein by reference.

### FIELD

The present disclosure relates to the field of artificial intelligence, and in particularly to a method and an apparatus for detecting an anomaly based on time information, an electronic device and a non-transitory computer-readable storage medium.

### BACKGROUND

In modern large-scale computing environments, a large number of logs generated by a system provide basic data for fault detection and system monitoring. However, most of existing methods for detecting a log rely on sliding analysis based on fixed time windows. This not only leads to detection results being affected by the reliability of the time windows but also leads to a lack of effective strategies for log data with complex time series. Especially when the time series involve seasonal variations, such variations are difficult to be captured by using conventional methods based on fixed windows.

### SUMMARY

An objective of the present disclosure is to provide a method and an apparatus for detecting an anomaly based on time information, an electronic device and a non-transitory computer-readable storage medium. According to the present disclosure, a preset detection period is divided into multiple preset time intervals, a pre-trained detection model is trained to learn baseline operating conditions of a target system during the respective preset time intervals, and a degree of deviation between an actual operating condition and the baseline operating condition of the target system during each of the multiple preset time intervals is determined by using the pre-trained detection model, to determine whether the target system is anomalous, thereby improving detection effectiveness.

To address the above-mentioned technical issues, a method for detecting an anomaly based on time information is provided according to the present disclosure. The method includes: dividing a preset detection period into multiple preset time intervals; performing different anomaly detection operations on log lines generated by a target system during each of the multiple preset time intervals to obtain anomaly scores of different detection types corresponding to the preset time interval; converting the anomaly scores to discrete anomaly scores, adding preset detection type tokens to the discrete anomaly scores to obtain marker token data, and adding a preset timestamp token to a timestamp corresponding to the preset time interval to obtain timestamp token data; and combining the timestamp token data corresponding to the preset time interval and the marker token data corresponding to the preset time interval to form a token sequence, performing anomaly detection on the token sequence by using a pre-trained detection model to obtain an overall anomaly score of the target system corresponding to the preset time interval, and determining whether the target system is anomalous based on the overall anomaly score, where the pre-trained detection model is trained to learn preset baseline token sequences corresponding to the respective preset time intervals, and the overall anomaly score represents a degree of deviation between the token sequence corresponding to the preset time interval and the preset baseline token sequence corresponding to the preset time interval.

In an embodiment, the method further includes: determining a quantity of the log lines generated by the target system during each of the multiple preset time intervals, and determining a sampling rate for each of the multiple preset time intervals based on the quantity; sampling the log lines generated by the target system during each of the multiple preset time intervals based on the sampling rate corresponding to the preset time interval. Where the performing different anomaly detection operations on log lines generated by a target system during each of the multiple preset time intervals includes: performing different anomaly detection operations on the sampled log lines during each of the multiple preset time intervals.

In an embodiment, the method further includes: converting the log lines generated by the target system during each of the multiple preset time intervals to log token data. Where the combining the timestamp token data corresponding to the preset time interval and the marker token data corresponding to the preset time interval to form a token sequence includes: combining the timestamp token data corresponding to the preset time interval, the marker token data corresponding to the preset time interval, and the log token data corresponding to the preset time interval to form the token sequence.

In an embodiment, the performing different anomaly detection operations on log lines generated by a target system during each of the multiple preset time intervals includes: combining the log lines to form a log sequence, and inputting the log sequence into a pre-trained log sequence detection model to obtain an anomaly score of a log sequence detection type, where the pre-trained log sequence detection model is trained to learn a preset normal log sequence, and the anomaly score of a log sequence detection type represents a degree of deviation between the log sequence and the normal log sequence; and/or, updating the log lines to a log parsing tree, and determining a variation degree of the log parsing tree between adjacent pairs of the multiple preset time intervals to obtain an anomaly score of a log structure detection type; and/or, determining, based on a preset log field to which each of the log lines belongs, a degree of deviation between an occurrence frequency of the present log field during a current preset time interval and an occurrence frequency of the present log field during a previous preset time interval of the current preset time interval to obtain an anomaly score of a log field detection type; and/or, extracting a discrete variable value from the log lines, and determining a degree of deviation between an occurrence frequency of each preset value corresponding to the discrete variable value during the current preset time interval and the occurrence frequency of the preset value during the previous preset time interval to obtain an anomaly score of a discrete detection type; and/or, extracting numerical values from the log lines, clustering the numerical values to obtain a numerical cluster, and determining a degree of deviation between numerical values not belonging to the numerical cluster and the numerical cluster to obtain an anomaly score of a numerical clustering detection type; and/or, converting multiple numerical values of the same type included in the log lines into a line chart to obtain a log rate, determining a numerical range for determining an outlier based on the log rate, and determining a ratio of numerical values falling outside the numerical range to all numerical values to obtain an anomaly score of a log rate detection type.

In an embodiment, the performing anomaly detection on the token sequence by using a pre-trained detection model to obtain an overall anomaly score of the target system corresponding to the preset time interval includes: masking a subset of token data in the token sequence to obtain a to-be-processed token sequence, where the masked token data in the to-be-processed token sequence includes the marker token data or a combination of the timestamp token data and the marker token data; inputting the to-be-processed token sequence into the pre-trained detection model, and predicting, by using the pre-trained detection model, the masked token data in the to-be-processed token sequence based on unmasked token data in the to-be-processed token sequence to obtain predicted token data; and calculating a loss between the predicted token data and the masked token data by using a preset loss function, and determining the loss as the overall anomaly score.

In an embodiment, the combining the timestamp token data corresponding to the preset time interval and the marker token data corresponding to the preset time interval to form a token sequence includes: combining the timestamp token data corresponding to the preset time interval and the marker token data corresponding to the preset time interval sequentially to form the token sequence; and the inputting the to-be-processed token sequence into the pre-trained detection model, and predicting, by using the pre-trained detection model, the masked token data in the to-be-processed token sequence based on unmasked token data in the to-be-processed token sequence to obtain predicted token data includes: inputting the to-be-processed token sequence into the pre-trained detection model, performing, by using the pre-trained detection model, positional encoding on all token data in the to-be-processed token sequence to obtain an encoding vector, and predicting, by using the pre-trained detection model, the masked token data in the to-be-processed token sequence based on the encoding vector and the unmasked token data in the to-be-processed token sequence to obtain the predicted token data.

In an embodiment, an overlap exists between adjacent pairs of the multiple preset time intervals, and the method further includes: inputting the token sequence into the pre-trained detection model, and predicting, by using the pre-trained detection model, a token sequence for a next preset time interval of a current preset time interval based on the token sequence to obtain a predicted token sequence; and calculating a sequence loss between the predicted token sequence and the token sequence for the next preset time interval by using the preset loss function, and determining whether the target system is anomalous based on the sequence loss.

In an embodiment, the pre-trained detection model is trained by: acquiring baseline token sequences for the respective preset time intervals, where the baseline token sequence corresponding to each of the multiple preset time intervals includes the timestamp token data for the preset time interval; masking a subset of token data in the baseline token sequence to obtain a to-be-trained token sequence; inputting the to-be-trained token sequence into an initial detection model, and predicting, by using the initial detection model, the masked token data in the to-be-trained token sequence based on unmasked token data in the to-be-trained token sequence to obtain to-be-compared token data; and calculating a training loss between the to-be-compared token data and the masked token data in the to-be-trained token sequence by using the preset loss function, and updating a parameter of the initial detection model based on the training loss to obtain the pre-trained detection model.

In an embodiment, the method further includes: constructing a timestamp vocabulary based on the timestamp token data corresponding to the respective preset time intervals; and configuring the timestamp vocabulary for the initial detection model, and predicting, by using the initial detection model, masked timestamp token data based on the timestamp vocabulary.

According to the present disclosure, an apparatus for detecting an anomaly based on time information is further provided. The apparatus includes: a time division module, a detection module, a token generation module, and a model detection module.

The time division module is configured to divide a preset detection period into multiple preset time intervals.

The detection module is configured to perform different anomaly detection operations on log lines generated by a target system during each of the multiple preset time intervals to obtain anomaly scores of different detection types corresponding to the preset time interval.

The token generation module is configured to convert the anomaly scores to discrete anomaly scores, add preset detection type tokens to the discrete anomaly scores to obtain marker token data, and add a preset timestamp token to a timestamp corresponding to the preset time interval to obtain timestamp token data.

The model detection module is configured to combine the timestamp token data corresponding to the preset time interval and the marker token data corresponding to the preset time interval to form a token sequence, perform anomaly detection on the token sequence by using a pre-trained detection model to obtain an overall anomaly score of the target system corresponding to the preset time interval, and determine whether the target system is anomalous based on the overall anomaly score. Where the pre-trained detection model is trained to learn preset baseline token sequences corresponding to the respective preset time intervals, and the overall anomaly score represents a degree of deviation between the token sequence corresponding to the preset time interval and the preset baseline token sequence corresponding to the preset time interval.

According to the present disclosure, an electronic device is further provided. The electronic device includes: a memory and a processor.

The memory is configured to store a computer program.

The processor is configured to execute the computer program to implement the method for detecting an anomaly based on time information described above.

According to the present disclosure, a non-transitory computer-readable storage medium is further provided. The non-transitory computer-readable storage medium stores a computer-executable instruction. The computer-executable instruction is loaded and executed by a processor to implement the method for detecting an anomaly based on time information described above.

The method for detecting an anomaly based on time information according to the present disclosure includes: dividing a preset detection period into multiple preset time intervals; performing different anomaly detection operations on log lines generated by a target system during each of the multiple preset time intervals to obtain anomaly scores of different detection types corresponding to the preset time interval; converting the anomaly scores into discrete anomaly scores, adding preset detection type tokens to the discrete anomaly scores to obtain marker token data, and adding a preset timestamp token to a timestamp corresponding to the preset time interval to obtain timestamp token data; and combining the timestamp token data corresponding to the preset time interval and the marker token data corresponding to the preset time interval to form a token sequence, performing anomaly detection on the token sequence by using a pre-trained detection model to obtain an overall anomaly score of the target system corresponding to the preset time interval, and determining whether the target system is anomalous based on the overall anomaly score, where the pre-trained detection model is trained to learn preset baseline token sequences corresponding to the respective preset time intervals, and the overall anomaly score represents a degree of deviation between the token sequence corresponding to the preset time interval and the preset baseline token sequence corresponding to the preset time interval.

### BRIEF DESCRIPTION OF THE DRAWINGS

To clearly illustrate technical solutions in embodiments of the present disclosure or in the related technology, drawings used for description of the embodiments or the related technology are introduced below briefly. Apparently, the drawings described below only show some embodiments of the present disclosure, and those skilled in the art may obtain other drawings based on these drawings without any creative work.

FIG. 1 is a flowchart of a method for detecting an anomaly based on time information according to an embodiment of the present disclosure;

FIG. 2 is a structural block diagram of an anomaly detection system according to an embodiment of the present disclosure;

FIG. 3 is a schematic diagram of an anomaly detection process according to an embodiment of the present disclosure;

FIG. 4 is a structural block diagram of an apparatus for detecting an anomaly based on time information according to an embodiment of the present disclosure; and

FIG. 5 is a structural block diagram of an electronic device according to an embodiment of the present disclosure.

### DETAILED DESCRIPTION

The technical solutions in the embodiments of the present disclosure are described clearly and completely as follows in conjunction with the drawings in the embodiments for a clear understanding of the purposes, technical solutions and advantages of the present disclosure. Apparently, the described embodiments are some rather than all of the embodiments of the present disclosure. All other embodiments obtained by those skilled in the art based on the embodiments of the present disclosure without any creative work fall within the protection scope of the present disclosure.

In modern large-scale computing environments, a large number of logs generated by a system provide basic data for fault detection and system monitoring. However, most of existing methods for detecting a log rely on sliding analysis based on fixed time windows. This not only leads to detection results being affected by the reliability of the time windows, but also leads to a lack of effective strategies for log data with complex time series. Especially when the time series involve seasonal variations, such variations are difficult to be captured by using conventional methods based on fixed windows.

In view of this, to address a technical issue of how to perform anomaly detection on a target system efficiently, a method for detecting an anomaly based on time information is provided according to the present disclosure. According to the present disclosure, a preset detection period is divided into multiple preset time intervals, a pre-trained detection model is trained to learn baseline operating conditions of the target system during the respective preset time intervals, and a degree of deviation between an actual operating condition and the baseline operating condition of the target system during each of the multiple preset time intervals is determined by using the pre-trained detection model, to determine whether the target system is anomalous, thereby improving detection effectiveness.

It should be noted that the target system described above refers to a system monitored by an anomaly detection system executing the present method, and may be any system capable of generating a log, such as a network system or an Internet of Things (IoT) system. The log involved may be a network traffic log or an IoT device log.

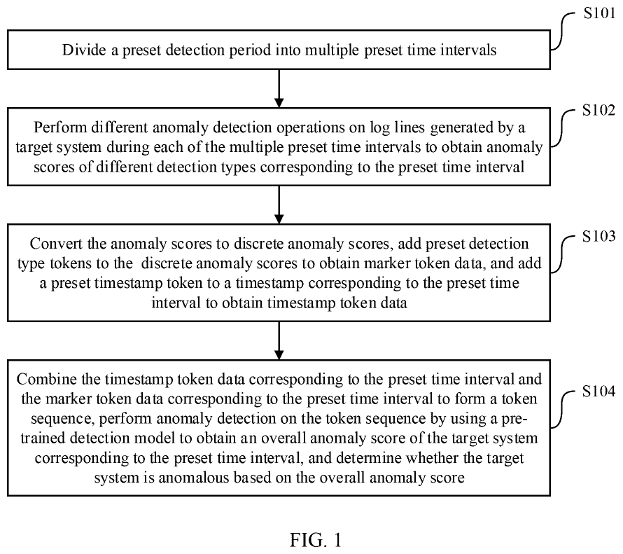

To facilitate understanding, reference is made to FIG. 1, which is a flowchart of a method for detecting an anomaly based on time information according to an embodiment of the present disclosure. The method includes steps S101 to S104.

In S101, a preset detection period is divided into multiple preset time intervals.

In this step, firstly, the preset detection period is divided into multiple preset time intervals, to determine periodical variations in an operating condition of a target system during the preset detection period by detecting the operating conditions of the target system during the respective preset time intervals.

It should be noted that the specific duration of the preset detection period is not limited in this embodiment, and may be set according to actual application requirements, such as one day, one week and one month. The specific duration of the preset time interval is not limited in this embodiment, and may be set according to actual application requirements, such as ten minutes, one hour and one day.

In addition, an overlap may or may not exist between adjacent pairs of the multiple preset time intervals. The overlapped preset time intervals may be, for example, 0:00 to 0:10, 0:05 to 0:15, 0:10 to 0:20, and 0:15 to 0:25, that is, an overlap of five minutes exists between a current time interval of ten minutes and a previous time interval of ten minutes.

In S102, different anomaly detection operations are performed on log lines generated by a target system during each of the multiple preset time intervals to obtain anomaly scores of different detection types corresponding to the preset time interval.

In this step, different anomaly detection operations are performed on the log lines generated by the target system during each of the multiple preset time intervals to perform preliminary anomaly detection on the target system from different perspectives and dimensions, and the anomaly scores of different detection types corresponding to the preset time interval is obtained. Where each of the anomaly scores represents an anomaly degree of the target system in one detection dimension. A higher anomaly score indicates a higher anomaly degree. On the contrary, a lower anomaly score indicates a lower anomaly degree. The detection types refer to types of the anomaly detection operations.

It should be noted that the specific anomaly detection operations are not limited in this embodiment and may be set according to actual application requirements or may be referred to descriptions in subsequent embodiments.

In S103, the anomaly scores are converted to discrete anomaly scores, preset detection type tokens are added to the discrete anomaly scores to obtain marker token data, and a preset timestamp token is added to a timestamp corresponding to the preset time interval to obtain timestamp token data.

In this step, since consecutive anomaly scores are unable to be processed by a model, the anomaly scores are converted to discrete anomaly scores to facilitate subsequent model processing and preset detection type tokens corresponding to the respective detection types are added to the discrete anomaly scores to obtain the marker token data. In addition, to provide time information for detection to the model, a preset timestamp token is added to the timestamp corresponding to the preset time interval to obtain the timestamp token data in this step. The marker token data and the timestamp token data described above are inputted into the model for processing at the same time.

It should be noted that a method for converting the anomaly scores to discrete anomaly scores is not limited in this embodiment. For example, if the anomaly scores range from 0 to 10, multiple interval ranges may be set with an interval of 1, namely 0 to 1, 1 to 2, 2 to 3 and the like. Then the anomaly scores may be converted to discrete anomaly scores based on the interval range in which each anomaly score falls. For example, an anomaly score of 1.1 may be converted to a discrete anomaly score of 2. The preset detection type token for each of the detection types is not limited in this embodiment, as long as the preset detection type tokens for respective detection types are different.

Further, since a detection period is set in advance and the preset detection period is divided into multiple preset time intervals in this embodiment, the multiple preset time intervals can be distinguished from each other based on a timestamp. Additionally, by converting the timestamp to a timestamp token and inputting the timestamp token into the model, it can be determined that an operating condition of the target system during which preset time interval is detected by using the model. Thus, whether an actual operating condition of the target system is anomalous is detected based on a baseline operating condition during the preset time interval by using the model. The specific preset timestamp token is not limited in this embodiment, as long as the preset timestamp token is different from the preset detection type tokens.

In S104, the timestamp token data corresponding to the preset time interval and the marker token data corresponding to the preset time interval are combined to form a token sequence, anomaly detection is performed on the token sequence by using a pre-trained detection model to obtain an overall anomaly score of the target system corresponding to the preset time interval, and whether the target system is anomalous is determined based on the overall anomaly score, where the pre-trained detection model is trained to learn preset baseline token sequences corresponding to the respective preset time intervals, and the overall anomaly score represents a degree of deviation between the token sequence corresponding to the preset time interval and the preset baseline token sequence corresponding to the preset time interval.

In this step, the timestamp token data corresponding to the preset time interval and the marker token data corresponding to the preset time interval are combined to form the token sequence, and anomaly detection is performed on the token sequence by inputting the token sequence into the pre-trained detection model to obtain the overall anomaly score of the target system corresponding to the preset time interval. The overall anomaly score represents an overall anomaly degree of the target system. A higher overall anomaly score indicates a higher overall anomaly degree of the target system, and a lower overall anomaly score indicates a lower overall anomaly degree of the target system.

It should be noted that the pre-trained detection model is trained to learn baseline token sequences corresponding to the respective preset time intervals. Thus, upon receiving the token sequence, the model may extract preset timestamp token data (that is, preset time interval information) from the token sequence, to determine whether other token data in the token sequence is normal based on the baseline token sequence for the preset time interval corresponding to the token sequence, and to determine whether the target system is normal. Alternatively, the model may extract other token data from the token sequence and may predict the preset time interval corresponding to the token sequence based on the baseline token sequences for the respective preset time intervals. If the predicted preset time interval is the same as the preset time interval corresponding to the token sequence, the target system is determined to be normal. On the contrary, if the predicted preset time interval is different from the preset time interval corresponding to the token sequence, the target system is determined to be anomalous.

In summary, since the pre-trained detection model is trained to learn baseline operating conditions of the target system during the respective preset time intervals, whether the target system is anomalous can be determined by determining a degree of deviation between an actual operating condition and the baseline operating condition of the target system during the preset time interval.

It should also be noted that the anomaly detection operation mainly focuses on anomalies of the target system from a single dimension, while the pre-trained detection model focuses on anomalies of the target system from a global dimension, and the combination of the two can avoid misjudgment caused by the single dimension. In an embodiment, during one of the multiple preset time intervals, one or more anomaly scores of the target system from a single dimension are relatively high consistently, and the relatively high anomaly scores are recorded in the baseline token sequence corresponding to the preset time interval. In this case, by performing the anomaly detection operation for a single dimension, the target system is determined to be anomalous, while by processing through the pre-trained detection model, the target system is determined to be normal. For example, for a network system, in a case that the system frequently experiences a surge in visits during a specific time interval, the surge in visits is determined as a normal phenomenon by the operation and maintenance personnel. By performing an anomaly detection operation for detecting the surge in visits, the target system is determined to be anomalous, which may lead to misjudgment. While by processing though the pre-trained detection model, the target system is determined to be normal, which avoids the misjudgment. Thus, a processing result of the model is closely consistent with a normal operating condition of the target system during the specific time interval. It can be seen that this embodiment enables comprehensive and reliable anomaly detection and can adapt to multi-dimensional anomalies in high-frequency and complex environment.

In addition, by using conventional methods for detecting an anomaly based on a fixed time window, only a log sequence within the fixed time window can be detected. For example, log lines during the most recent period of time are always detected. This leads to two issues described below. First, the fixed time window ignores the operating condition of the target system at each specified time instant, resulting in it being unable to determine whether the target system operates normally at the specified time instant. Second, the fixed time window makes it difficult to detect seasonal variations in the operating condition of the target system. For example, when the seasonal variations in the operating condition of the target system last for a long period, the conventional methods can only extend the fixed time window, which directly results in a large amount of log lines to be processed at the same time through the conventional methods. In this case, substantial resources are consumed, and an unsatisfactory detection result is achieved. In this embodiment, the model is trained to learn the operating conditions of the target system during the respective preset time intervals in the preset detection period, the token sequence includes timestamp information that facilitates the model in determining a time point, and each preset time interval has a short duration with its log lines being much fewer than all log lines of the preset detection period. Thus, the model can effectively learn the operating conditions of the target system at all specified time instant and can detect the operating condition of the system at the specified time instant. In addition, high detection efficiency can be achieved due to a small quantity of the log lines for each preset time interval. Based on this, the present disclosure can adapt well to the seasonal variations in the operating condition of the target system.

Further, in a normal operation condition, the operating condition of the target system is closely related to time information. That is, the marker token data, log token data, and the timestamp token data are closely related to each other. To explicitly embody this correlation in the token sequence and highlight the function of the timestamp token data, the timestamp token data, the marker token data and the log token data are sequentially combined to form the token sequence, which facilitates the model in learning and determining the correlation among all token data.

Based on this, the combining the timestamp token data corresponding to the preset time interval and the marker token data corresponding to the preset time interval to form a token sequence includes step S11.

In step S11, the timestamp token data corresponding to the preset time interval and the marker token data corresponding to the preset time interval are sequentially combined to form the token sequence.

Similarly, the marker token data for the respective detection types may also be sequentially arranged to facilitate the model in determining the correlation among the marker token data for the various detection types.

Further, in addition to processing the marker token data and the timestamp token data, the pre-trained detection model may also perform model detection in conjunction with the content of log lines. In an embodiment, the log lines generated by the target system during each of the multiple preset time intervals are converted to log token data, and the marker token data, the timestamp token data and the log token data are combined to form a token sequence, so that the pre-trained detection model can further analyze log information.

Based on this, the method further includes step S21.

In step S21, the log lines generated by the target system during each of the multiple preset time intervals are converted to log token data.

The combining the timestamp token data corresponding to the preset time interval and the marker token data corresponding to the preset time interval to form a token sequence includes step S31.

In step S31, the timestamp token data corresponding to the preset time interval, the marker token data corresponding to the preset time interval and the log token data corresponding to the preset time interval are combined to form the token sequence.

Similarly, the timestamp token corresponding to the preset time interval, the marker token data corresponding to the preset time interval and the log token data corresponding to the preset time interval may be sequentially combined to form the token sequence.

It should be noted that a method for converting the log lines to the log token data is not limited in this embodiment, as long as all the log lines can be represented by a small number of tokens and the tokens are determined as the log token data. For example, by using DRAIN algorithm, the log lines can be parsed and converted to log tokens, to determine the log tokens as the log token data. The DRAIN algorithm is a method for parsing a log online based on a fixed-depth tree.

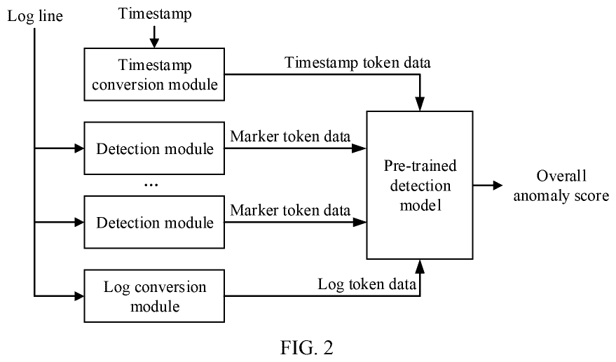

To facilitate understanding, reference is made to FIG. 2, which is a structural block diagram of an anomaly detection system according to an embodiment of the present disclosure. The anomaly detection system includes a timestamp conversion module, a detection module, a log conversion module, and a pre-trained detection model. The timestamp conversion module is configured to generate the timestamp token data. The detection module is configured to perform anomaly detection operations to obtain the marker token data. The log conversion module is configured to convert the log lines to the log token data.

Based on the above embodiments of the present disclosure, a preset detection period is divided into multiple preset time intervals firstly, and different anomaly detection operations are performed on log lines generated by a target system during each of the multiple preset time intervals to obtain anomaly scores of different detection types corresponding to the preset time interval. Subsequently, the anomaly scores are converted to discrete anomaly scores, preset detection type tokens are added to the discrete anomaly scores to obtain marker token data, and a preset timestamp token is added to a timestamp corresponding to the preset time interval to obtain timestamp token data. The timestamp token data corresponding to the preset time interval and the marker token data corresponding to the preset time interval are combined to form a token sequence, and anomaly detection is performed on the token sequence by using a pre-trained detection model to obtain an overall anomaly score of the target system corresponding to the preset time interval. Whether the target system is anomalous is determined based on the overall anomaly score. The pre-trained detection model is trained to learn preset baseline token sequences corresponding to the respective preset time intervals. The overall anomaly score represents a degree of deviation between the token sequence corresponding to the preset time interval and the preset baseline token sequence corresponding to the preset time interval. During the preset detection period, periodical variations may exist in the operating condition of the target system, and the target system typically exhibits a specified operating condition during a specified time interval. Therefore, according to the present disclosure, the pre-trained detection model is trained to learn the preset baseline token sequences of the target system corresponding to the respective preset time intervals. That is, the pre-trained detection model is trained to learn the specified operating conditions of the target system corresponding to the respective preset time intervals. Furthermore, during an online detection process in the present disclosure, the token sequences generated by the target system corresponding to the respective time intervals can be identified by using the pre-trained detection model, to determine whether the target system is anomalous, thereby improving the reliability of the anomaly detection for log sequence.

Based on the above embodiments, a specific process of performing anomaly detection on the token sequence by using the pre-trained detection model is described as follows. Based on this, the performing anomaly detection on the token sequence by using a pre-trained detection model to obtain an overall anomaly score of the target system corresponding to the preset time interval includes steps S201 to S203.

In S201, a subset of token data in the token sequence are masked to obtain a to-be-processed token sequence, and the masked token data in the to-be-processed token sequence includes the marker token data or a combination of the timestamp token data and the marker token data.

In S202, the to-be-processed token sequence is inputted into the pre-trained detection model, and the masked token data in the to-be-processed token sequence is predicted by using the pre-trained detection model based on unmasked token data in the to-be-processed token sequence to obtain predicted token data.

In S203, a loss between the predicted token data and the masked token data is calculated by using a preset loss function, and the loss is determined as the overall anomaly score.

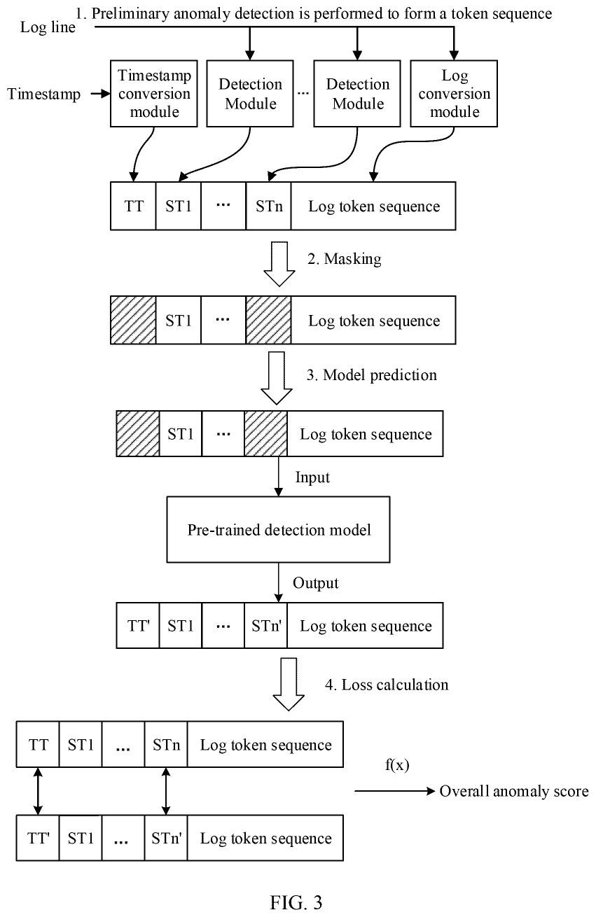

Reference is made to FIG. 3, which is a schematic diagram of an anomaly detection process according to an embodiment of the present disclosure. The process of generating the overall anomaly score includes four steps as follows.

In a first step, log lines are inputted into various detection modules to obtain marker token data (ST1 to STn) corresponding to the respective detection types, the log lines are inputted into a log conversion module to obtain log token data, and a timestamp corresponding to a preset time interval is inputted into a timestamp conversion module to obtain timestamp token data (TT). Subsequently, the timestamp token data, the marker token data and the log token data are combined to form a token sequence. As described above, in a normal operating condition, the operating condition of a target system is closely related to time information. That is, the marker token data, the log token data, and the timestamp token data are closely related to each other. To explicitly embody this correlation in the token sequence and highlight the function of the timestamp token data, the timestamp token data, the marker token data and the log token data are sequentially combined to form the token sequence. In a model training stage, by using an initial detection model, positional encoding may be performed on all token data in the token sequence to mark a position of each token data in the sequence, and the correlation among all token data is learned. Particularly, the correlation among the timestamp token data, the marker token data and the log token data (that is, the correlation between the time information and baseline conditions of the target system) is learned. In an online inference stage, by using a pre-trained detection model, positional encoding may be performed on all token data in the token sequence, and the function of each token data and the correlation among all token data are determined based on the position of each token data in the sequence. Particularly, the function of the timestamp token data and the correlation between the timestamp token data and other token data, to efficiently perform parsing or inference prediction on other token data based on the timestamp token data.

It should be noted that the position of various token data in the token sequence is not limited in this embodiment. For example, the sequence may be: the timestamp token data, the marker token data, and the log token data. Similarly, the marker token data for the respective detection types may also be arranged sequentially to facilitate the model in determining the correlation among the marker token data for the various detection types. A specific method for positional encoding is not limited in this embodiment, and reference may be made to related technologies of a transformer model.

In a second step, a subset of token data in the token sequence is masked to obtain a to-be-processed token sequence including masked token data and unmasked token data. In an embodiment, a subset of token data may be randomly selected from the timestamp token data and the marker token data for masking. For example, the masked token data includes the marker token data or a combination of the timestamp token data and the marker token data.

It should be noted that in a case that the timestamp token data is unmasked, the model may detect whether the operating condition of the target system during a preset time interval corresponding to the timestamp token data is normal. In a case that the timestamp token data is masked, the model may detect whether the preset time interval corresponding to the to-be-processed token sequence is the preset time interval corresponding to the timestamp token data. Further, in a case that the token sequence includes the log token data, a subset of token data may be randomly selected from the log token data for masking. To facilitate understanding, in FIG. 3, portions covered by slash lines represent the masked token data, and portions not covered by slash lines represent the unmasked token data.

In a third step, the to-be-processed token sequence is inputted into the pre-trained detection model to obtain a predicted token sequence outputted from the pre-trained detection model. In FIG. 3, TT″ and STn′ represent the predicted token data corresponding to the masked token data. By using the pre-trained detection model, the masked token data in the to-be-processed token sequence is predicted based on the learned baseline token sequences and the unmasked token data in the to-be-processed token sequence. That is, by using the pre-trained detection model, the masked token data in the to-be-processed token sequence is complemented based on baseline operating conditions during the respective preset time intervals.

In a fourth step, a loss between the predicted token data and the masked token data in the to-be-processed token sequence is calculated by using a preset loss function, and the loss is determined as the overall anomaly score. In FIG. 3, f(x) represents the preset loss function. In an embodiment, the pre-trained detection model is used to predict the masked token data in the to-be-processed token sequence based on the baseline operating conditions, and actual values of the masked token data may deviate from the baseline operating conditions, that is, the masked token data may differ from the predicted token data. Thus, in this embodiment, the preset loss function may be used to calculate the loss between the predicted token data and the masked token data, and the loss is determined as the overall anomaly score. The loss represents a difference between the masked token data and the predicted token data, and further represents a difference between an actual operating condition and the baseline operating condition of the target system during a current time interval. In this way, overall detection of the target system is achieved in this embodiment.

It should be noted that a specific pre-trained detection model is not limited in this embodiment. Since the module is used to predict the masked token sequence, the model belongs to a masked language model (MLM). For example, the pre-trained detection model may be a bidirectional encoder representation from transformer (BERT) model. A process of processing the token sequence by using the pre-trained detection model is not limited in this embodiment, and reference may be made to related technologies of a BERT model. It should be noted that by using the pre-trained detection model, positional encoding may be performed on all token data in the to-be-processed token sequence firstly to obtain an encoding vector, the function of each token data in the to-be-processed token sequence and the correlation among all token data are determined based on the encoding vector, and the masked token data is predicted.

Based on this, the inputting the to-be-processed token sequence into the pre-trained detection model, and predicting, by using the pre-trained detection model, the masked token data in the to-be-processed token sequence based on unmasked token data in the to-be-processed token sequence to obtain predicted token data includes step S41.

In step S41, the to-be-processed token sequence is inputted into the pre-trained detection model, positional encoding is performed on all token data in the to-be-processed token sequence by using the pre-trained detection model to obtain an encoding vector, and the masked token data in the to-be-processed token sequence is predicted by using the pre-trained detection model based on the encoding vector and the unmasked token data in the to-be-processed token sequence to obtain the predicted token data.

It should be noted that a specific form of the preset loss function is not limited in this embodiment, a loss function used in a model training process may be determined as the preset loss function, and reference may be made to the related technology of training an MLM model.

Based on the above embodiments, in a case that an overlap exists between adjacent pairs of the multiple preset time intervals, a predicted token sequence for a next time interval of a current time interval is generated by using the pre-trained detection model based on the token sequence for the current time interval, and anomaly detection is performed on a token sequence for the next time interval by using the predicted token sequence. A process of predicting the token sequence is described as follows. Based on this, in a case that the overlap exists between adjacent pairs of the multiple preset time intervals, the method further includes steps S301 and S302.

In S301, the token sequence is inputted into the pre-trained detection model, and a token sequence for a next preset time interval of a current preset time interval is predicted by using the pre-trained detection model based on the token sequence to obtain a predicted token sequence.

In this embodiment, due to the overlap between the preset time intervals, the log lines of the current time interval include some of the log lines of the next time interval. That is, the operating condition of the target system during the next time interval is related to the operating condition of the target system during the current time interval. Thus, in this step, the token sequence is inputted into the pre-trained detection model, and a token sequence for the next preset time interval is predicted by using the pre-trained detection model based on the token sequence to obtain a predicted token sequence. In this way, the target system is determined to be anomalous when a large deviation exists between an actual token sequence for the next time interval and the predicted token sequence.

It should be noted that the token sequence can be predicted by using the MLM model based on a next sentence prediction (NSP) mechanism, and reference may be made to related technologies of NSP.

In S302, a sequence loss between the predicted token sequence and the token sequence for the next preset time interval is calculated by using the preset loss function, and whether the target system is anomalous is determined based on the sequence loss.

In this step, the sequence loss between the predicted token sequence and the token sequence for the next preset time interval is calculated by using the preset loss function. The sequence loss represents a difference between the predicted token sequence and the token sequence for the next preset time interval and further represents a difference between an expected operating condition and an actual operating condition of the target system during the next time interval. In this way, an accuracy of the anomaly detection is improved.

Based on the above embodiments, a process of training the pre-trained detection model is described as follows. Before the model is trained, considering that the timestamp token data is separately set in this embodiment and is unidentifiable by the conventional MLM model, and considering that the preset time intervals included in the preset detection period are determined in advance in this embodiment, that is, the specific value of the timestamp token data can be determined in advance, a timestamp vocabulary may be constructed based on the timestamp token data corresponding to the respective preset time intervals, and the timestamp vocabulary may be configured for the initial detection model. Based on this, the method further includes steps S401 and S402.

In S401, a timestamp vocabulary is constructed based on the timestamp token data corresponding to the respective preset time intervals.

In S402, the timestamp vocabulary is configured for the initial detection model, and masked timestamp token data is predicted by using the initial detection model based on the timestamp vocabulary.

In this case, the preset time intervals may be processed as independent token data to form a vocabulary. For example, one day includes 144 ten-minute intervals, and one week includes 1008 such intervals. As a core input for prediction, time information is used together with other token data signals for sequence processing during model training.

A specific process of training the pre-trained detection model is described below, which includes steps S501 to S504.

In S501, the baseline token sequences for the respective preset time intervals are acquired, where the baseline token sequence corresponding to each of the multiple preset time intervals includes the timestamp token data for the preset time interval.

In S502, a subset of token data in the baseline token sequence is masked to obtain a to-be-trained token sequence.

In S503, the to-be-trained token sequence is inputted into an initial detection model, and the masked token data in the to-be-trained token sequence is predicted by using the initial detection model based on unmasked token data in the to-be-trained token sequence to obtain to-be-compared token data.

In S504, a training loss between the to-be-compared token data and the masked token data in the to-be-trained token sequence is calculated by using the preset loss function, and a parameter of the initial detection model is updated on based on the training loss to obtain the pre-trained detection model.

Similar to the above-mentioned embodiment, a subset of the token data in the baseline token sequence is masked in this embodiment, to obtain the to-be-trained token sequence including the masked token data and the unmasked token data. Subsequently, the to-be-trained token sequence may be inputted into the initial detection model. By using the initial detection model, the masked token data in the to-be-trained token sequence is predicted based on the unmasked token data in the to-be-trained token sequence to obtain the to-be-compared token data. In a case that the baseline token sequence includes the timestamp token data, the marker token data and the log token data which are sequentially combined, positional encoding may be firstly performed on all token data in the to-be-trained token sequence by using the pre-trained detection model, and the function of each token data in the to-be-trained token sequence and the correlation among all token data are determined based on the encoding, thereby predicting the masked token data. After the to-be-compared token data corresponding to the respective masked token data is obtained, the loss between the to-be-compared token data and the masked token data in the to-be-trained token sequence is calculated by using the preset loss function in this embodiment. Unlike the above-mentioned embodiment, since the initial detection model is trained herein, the parameter of the initial detection model is to be updated based on the loss to obtain the pre-trained detection model. The above training process may be repeated several times until the performance of the pre-trained detection model satisfies application requirements.

Based on the above-mentioned embodiment, considering that a large amount of log lines may be generated during operation of the target system, it is not practical to perform anomaly detection on all of the log lines. Thus, the log lines may be sampled to reduce a quantity of the log lines to be processed actually. Also, considering that the quantity of the log lines generated by the target system varies across different preset time intervals, employing the same sampling rate for different preset time intervals fails to balance the quantities of the log lines of different preset time intervals, which affects the processing performance of the model. Thus, in this embodiment, the quantity of the log lines generated by the target system during each of the multiple preset time intervals is determined in advance, and a corresponding sampling rate is set based on the quantity of the log lines to balance the quantities of the log lines of different preset time intervals. Based on this, the method further includes steps S601 and S602.

In S601, a quantity of the log lines generated by the target system during each of the multiple preset time intervals is determined, and a sampling rate for each of the multiple preset time intervals is determined based on the quantity.

In S602, the log lines generated by the target system during each of the multiple preset time intervals are sampled based on the sampling rate corresponding to the preset time interval.

It should be noted that a method for determining the sampling rate based on the quantity is not limited in this embodiment, as long as the sampling rate matches the quantity of the log lines. For example, the sampling rate may be in a proportional relationship with the quantity of the log lines, which is set based on actual application requirements.

Further, when different anomaly detection operations are performed on the log lines generated by the target system during each of the multiple preset time intervals, different anomaly detection operations are performed on the sampled log lines during each of the multiple preset time interval.

Based on the above-mentioned embodiment, specific contents of the anomaly detection operations are described as follows. In an embodiment, the performing different anomaly detection operations on log lines generated by a target system during each of the multiple preset time intervals includes step S51.

In step S51, the log lines are combined to form a log sequence, and the log sequence is inputted into a pre-trained log sequence detection model to obtain an anomaly score of a log sequence detection type, where the pre-trained log sequence detection model is trained to learn a preset normal log sequence, and the anomaly score of a log sequence detection type represents a degree of deviation between the log sequence and the normal log sequence.

In this embodiment, the log sequence may be detected by using the pre-trained log sequence detection model. The pre-trained log sequence detection model is trained to learn the preset normal log sequence. Thus, by using the pre-trained log sequence detection model, the inputted log sequence is compared with the normal log sequence, to generate the anomaly score of a log sequence detection type. The anomaly score represents the degree of deviation between the log sequence and the normal log sequence. In this way, anomalies in the log sequence can be detected in time in this embodiment.

It should be noted that a specific type of the pre-trained log sequence detection model is not limited in this embodiment. For example, it may be a logBERT model. For a specific process of detecting the log sequence, reference may be made to related technologies of logBERT. A method for converting and combining the log lines to form the log sequence is not limited in this embodiment. For example, DRAIN algorithm may be used to convert the log lines to log tokens, and to combine the log tokens to form the log sequence. The DRAIN algorithm is a method for parsing a log online based on a fixed-depth tree.

In an embodiment, the performing different anomaly detection operations on log lines generated by a target system during each of the multiple preset time intervals includes step S61.

In step S61, the log lines are updated to a log parsing tree, and a variation degree of the log parsing tree between adjacent pairs of the multiple preset time intervals is determined to obtain an anomaly score of a log structure detection type.

In this embodiment, variations of the log parsing tree at different time instants may be detected. The log parsing tree is a multi-level hierarchical structure constructed based on the log lines and is configured to parse a log. The log parsing tree may be generated by using the DRAIN algorithm. For specific generation methods, reference may be made to related technologies of the DRAIN algorithm. In an embodiment, the log lines may be updated to the log parsing tree, and the variation degree of the log parsing tree between adjacent pairs of the multiple preset time intervals is detected to obtain the anomaly score of a log structure detection type. In this way, variations of the log parsing tree can be determined in time from a perspective of log structure in this embodiment.

It should be noted that a method for calculating the variation degree of the log parsing tree between different time intervals is not limited in this embodiment. For example, Jensen-Shannon drift divergence (JSD) algorithm may be used for calculation.

In an embodiment, the performing different anomaly detection operations on log lines generated by a target system during each of the multiple preset time intervals includes step S71.

In step S71, based on a preset log field to which each of the log lines belongs, a degree of deviation between an occurrence frequency of the present log field during a current preset time interval and an occurrence frequency of the present log field during a previous preset time interval of the current preset time interval is determined to obtain an anomaly score of a log field detection type.

In this embodiment, variations in a frequency of the respective preset log fields may be detected, and the variations may be quantified as the anomaly score. In an embodiment, based on the preset log field to which each of the log lines belongs, the degree of deviation between the occurrence frequency of the present log field during the current preset time interval and the occurrence frequency of the present log field during the previous preset time interval may be determined to obtain the anomaly score of a log field detection type. In this way, variations in distribution of the respective log fields can be determined in time from a perspective of log top field in this embodiment.

It should be noted that the specific preset log fields are not limited in this embodiment and may be set based on actual application requirements. A method for calculating the degree of deviation between occurrence frequencies of the preset log field is not limited in this embodiment. For example, the above-mentioned JSD algorithm may be used for calculation.

In an embodiment, the performing different anomaly detection operations on log lines generated by a target system during each of the multiple preset time intervals includes step S81.

In step S81, a discrete variable value is extracted from the log lines, and a degree of deviation between an occurrence frequency of each preset value corresponding to the discrete variable value during the current preset time interval and the occurrence frequency of the preset value during the previous preset time interval is determined to obtain an anomaly score of a discrete detection type.

In this embodiment, the discrete variable value refers to a variable value with multiple preset values. The target system may select a value for the discrete variable value from the multiple preset values. For such values, the degree of deviation between the occurrence frequency of each preset value corresponding to the discrete variable value during the current preset time interval and the occurrence frequency of the preset value during the previous preset time interval may be determined to obtain the anomaly score of a discrete detection type. In this way, anomalous variations in the value of the discrete variable value can be detected in time from a perspective of discrete variable value in this embodiment.

It should be noted that a method for calculating the degree of deviation between the occurrence frequencies of each value of the discrete value is not limited in this embodiment. For example, the above-mentioned JSD algorithm may be used for calculation.

In an embodiment, the performing different anomaly detection operations on log lines generated by a target system during each of the multiple preset time intervals includes step S91.

In step S91, numerical values are extracted from the log lines, the numerical values are clustered to obtain a numerical cluster, and a degree of deviation between numerical values not belonging to the numerical cluster and the numerical cluster is determined to obtain an anomaly score of a numerical clustering detection type.

In this embodiment, clustering detection may be performed on the numerical values, and outlier conditions may be detected based on the numerical cluster obtained by clustering. For example, the degree of deviation between the numerical values not belonging to the numerical cluster and the numerical cluster is calculated, to obtain the anomaly score of a numerical clustering detection type. In this way, anomalous outlier conditions of the numerical values can be determined in time from a perspective of numerical cluster in this embodiment.

It should be noted that a method for clustering the numerical values is not limited in this embodiment, and reference may be made to related technologies of clustering algorithms. For example, a density-based spatial clustering of applications with noise (DBSCAN) algorithm may be used for clustering.

In an embodiment, the performing different anomaly detection operations on log lines generated by a target system during each of the multiple preset time intervals includes step S101.

In step S101, multiple numerical values of the same type included in the log lines are converted into a line chart to obtain a log rate, a numerical range for determining an outlier is determined based on the log rate, and a ratio of numerical values falling outside the numerical range to all numerical values is determined to obtain an anomaly score of a log rate detection type.

In this embodiment, fluctuating numerical values may be fitted into a line chart to obtain a log rate, to reflect fluctuations of the numerical values over time. Subsequently, the numerical range for determining an outlier may be determined based on the log rate. The numerical range is configured for determining outliers. For example, numerical values falling within the range are non-outliers, and numerical values falling outside the range are outliers. In brief, the numerical range is used for determining numerical values with an anomalous fluctuating amplitude. In this way, anomalous fluctuations of the fluctuating numerical values can be determined in time from a perspective of log rate in this embodiment.

It should be noted that the numerical range for determining an outlier may be constructed through multiple methods. For example, the numerical range may be constructed based on a prediction range algorithm (e.g., Facebook Prophet algorithm) and may also be obtained by calculating a standard deviation of the numerical values included in the line chart and determining a preset multiple of the standard deviation as an upper/lower limit of the range.

It should be noted that the above anomaly detection operations may be set according to actual requirements. In addition to the above anomaly detection operations, other anomaly detection operations may also be employed according to actual application requirements.

An apparatus for detecting an anomaly based on time information, an electronic device, a computer program product and a non-transitory computer-readable storage medium according to the embodiments of the present disclosure are described as follows. The apparatus for detecting an anomaly based on time information, the electronic device, the computer program product and the non-transitory computer-readable storage medium described below and the method for detecting an anomaly based on time information described above can be referred to each other.

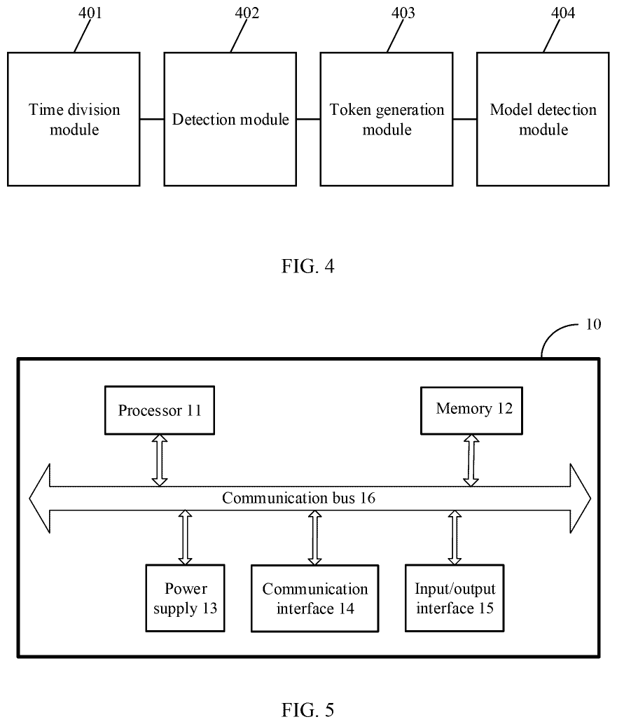

Reference is made to FIG. 4, which is a structural block diagram of an apparatus for detecting an anomaly based on time information according to an embodiment of the present disclosure. The apparatus includes: a time division module 401, a detection module 402, a token generation module 403, and a model detection module 404.

The time division module 401 is configured to divide a preset detection period into multiple preset time intervals.

The detection module 402 is configured to perform different anomaly detection operations on log lines generated by a target system during each of the multiple preset time intervals to obtain anomaly scores of different detection types corresponding to the preset time interval.

The token generation module 403 is configured to convert the anomaly scores to discrete anomaly scores, add preset detection type tokens to the discrete anomaly scores to obtain marker token data, and add a preset timestamp token to a timestamp corresponding to the preset time interval to obtain timestamp token data.

The model detection module 404 is configured to combine the timestamp token data corresponding to the preset time interval and the marker token data to form a token sequence, perform anomaly detection on the token sequence by using a pre-trained detection model to obtain an overall anomaly score of the target system corresponding to the preset time interval, and determine whether the target system is anomalous based on the overall anomaly score, where the pre-trained detection model is trained to learn preset baseline token sequences corresponding to the respective preset time intervals, and the overall anomaly score represents a degree of deviation between the token sequence corresponding to the preset time interval and the preset baseline token sequence corresponding to the preset time interval.

In an embodiment, the apparatus further includes: a sampling rate determination module and a sampling rate module.

The sampling rate determination module is configured to determine a quantity of the log lines generated by the target system during each of the multiple preset time intervals and determine a sampling rate for each of the multiple preset time intervals based on the quantity.

The sampling rate module is configured to sample the log lines generated by the target system during each of the multiple preset time intervals based on the sampling rate corresponding to the preset time interval.

The detection module 402 is further configured to: perform different anomaly detection operations on the sampled log lines during each of the multiple preset time intervals.

In an embodiment, the apparatus further includes: a log conversion module.

The log conversion module is configured to convert the log lines generated by the target system during each of the multiple preset time intervals to log token data.

The model detection module 404 includes: a sequence generation module.

The sequence generation module is configured to combine the timestamp token data corresponding to the preset time interval, the marker token data corresponding to the preset time interval and the log token data corresponding to the preset time interval to form the token sequence.

In an embodiment, the detection module 402 includes: a log sequence detection sub-module, and/or a log structure detection sub-module, and/or a log field detection sub-module, and/or a discrete variable value detection sub-module, and/or a clustering detection sub-module, and/or a log rate detection sub-module.

The log sequence detection sub-module is configured to combine the log lines to form a log sequence, and input the log sequence into a pre-trained log sequence detection model to obtain an anomaly score of a log sequence detection type, where the pre-trained log sequence detection model is trained to learn a preset normal log sequence, and the anomaly score of a log sequence detection type represents a degree of deviation between the log sequence and the normal log sequence.

The log structure detection sub-module is configured to update the log lines to a log parsing tree and determine a variation degree of the log parsing tree between adjacent pairs of the multiple preset time intervals to obtain an anomaly score of a log structure detection type.

The log field detection sub-module is configured to determine, based on a preset log field to which each of the log lines belongs, a degree of deviation between an occurrence frequency of the present log field during a current preset time interval and an occurrence frequency of the present log field during a previous preset time interval of the current preset time interval to obtain an anomaly score of a log field detection type.

The discrete variable value detection sub-module is configured to extract a discrete variable value from the log lines, and determine a degree of deviation between an occurrence frequency of each preset value corresponding to the discrete variable value during the current preset time interval and the occurrence frequency of the preset value during the previous preset time interval to obtain an anomaly score of a discrete detection type.

The clustering detection sub-module is configured to extract numerical values from the log lines, cluster the numerical values to obtain a numerical cluster, and determine a degree of deviation between numerical values not belonging to the numerical cluster and the numerical cluster to obtain an anomaly score of a numerical clustering detection type.

The log rate detection sub-module is configured to convert multiple numerical values of the same type included in the log lines into a line chart to obtain a log rate, determine a numerical range for determining an outlier based on the log rate, and determine a ratio of numerical values falling outside the numerical range to all numerical values to obtain an anomaly score of a log rate detection type.

In an embodiment, the model detection marker 404 includes: a masking sub-module, a detection sub-module, and an anomaly score calculation sub-module.

The masking sub-module is configured to mask a subset of token data in the token sequence to obtain a to-be-processed token sequence, where the masked token data in the to-be-processed token sequence includes the marker token data or a combination of the timestamp token data and the marker token data.

The detection sub-module is configured to input the to-be-processed token sequence into the pre-trained detection model, and predict, by using the pre-trained detection model, the masked token data in the to-be-processed token sequence based on unmasked token data in the to-be-processed token sequence to obtain predicted token data.

The anomaly score calculation sub-module is configured to calculate a loss between the predicted token data and the masked token data by using a preset loss function and determine the loss as the overall anomaly score.

In an embodiment, the model detection module 404 includes: a sequence combination sub-module, and a model processing sub-module.

The sequence combination sub-module is configured to combine the timestamp token data corresponding to the preset time interval and the marker token data corresponding to the preset time interval sequentially to form the token sequence.

The model processing sub-module is configured to input the to-be-processed token sequence into the pre-trained detection model, perform, by using the pre-trained detection model, positional encoding on all token data in the to-be-processed token sequence to obtain an encoding vector, and predict, by using the pre-trained detection model, the masked token data in the to-be-processed token sequence based on the encoding vector and the unmasked token data in the to-be-processed token sequence to obtain the predicted token data.

In an embodiment, an overlap exists between adjacent pairs of the multiple preset time intervals.

The model detection module 404 includes: a prediction sub-module, and a sequence anomaly score calculation sub-module.

The prediction sub-module is configured to input the token sequence into the pre-trained detection model, and predict, by using the pre-trained detection model, a token sequence for a next preset time interval of a current preset time interval based on the token sequence to obtain a predicted token sequence.

The sequence anomaly score calculation sub-module is configured to calculate a sequence loss between the predicted token sequence and the token sequence for the next preset time interval by using the preset loss function and determine whether the target system is anomalous based on the sequence loss.

In an embodiment, the apparatus may further include: an acquisition module, a training data setting module, a training module, and a parameter update module.

The acquisition module is configured to acquire the baseline token sequences for the respective preset time intervals, where the baseline token sequence corresponding to each of the multiple preset time intervals includes the timestamp token data for the preset time interval.

The training data setting module is configured to mask a subset of token data in the baseline token sequence to obtain a to-be-trained token sequence.

The training module is configured to input the to-be-trained token sequence into an initial detection model, and predict, by using the initial detection model, the masked token data in the to-be-trained token sequence based on unmasked token data in the to-be-trained token sequence to obtain to-be-compared token data.

The parameter update module is configured to calculate a training loss between the to-be-compared token data and the masked token data in the to-be-trained token sequence by using the preset loss function and update a parameter of the initial detection model based on the training loss to obtain the pre-trained detection model.

In an embodiment, the apparatus further includes: a vocabulary setting module, and a vocabulary addition module.

The vocabulary setting module is configured to construct a timestamp vocabulary based on the timestamp token data corresponding to the respective preset time intervals.

The vocabulary addition module is configured to configure the timestamp vocabulary for the initial detection model, and predict, by using the initial detection model, masked timestamp token data based on the timestamp vocabulary.

Reference is made to FIG. 5, which is a structural block diagram of an electronic device according to an embodiment of the present disclosure. An electronic device 10 is provided according to an embodiment of the present disclosure. The electronic device 10 includes a processor 11 and a memory 12. The memory 12 is configured to store a computer program. The processor 11 is configured to execute the computer program to implement the method for detecting an anomaly based on time information according to the above-mentioned embodiments.

A specific process of the aforementioned method for detecting an anomaly based on time information may be referred to the corresponding description in the above embodiments, which is not repeated herein.

In addition, the memory 12, serving as a carrier for resource storage, may be a read-only memory (ROM), a random access memory (RAM), a disk, an optical disk and the like, and its storage mode may be temporary storage or permanent storage.

In addition, the electronic device 10 further includes a power supply 13, a communication interface 14, an input/output interface 15, and a communication bus 16. The power supply 13 is configured to provide an operating voltage for each hardware device on the electronic device 10. The communication interface 14 is able to create a data transmission channel between the electronic device 10 and an external device. The data transmission channel follows a communication protocol applicable to the technical solutions of the present disclosure, which is not specifically limited herein. The input/output interface 15 is configured to receive data from the external or output data to the external. A specific type of the input/output interface may be determined based on a specific application, which is not specifically limited herein.

A computer program product is further provided according to an embodiment of the present disclosure. The computer program product includes a computer program/instruction. The computer program/instruction, when executed by a processor, causes the processor to implement the method for detecting an anomaly based on time information as described in the above embodiments.

Embodiments of the computer program product correspond to those of the method for detecting an anomaly based on time information. Thus, description of the computer program product embodiments may refer to that of the method embodiments, and details are not repeated herein.

A non-transitory computer-readable storage medium is further provided according to an embodiment of the present disclosure. The non-transitory computer-readable storage medium stores a computer program. The computer program, when executed by a processor, causes the processor to implement the method for detecting an anomaly based on time information as described in the above embodiments.

Embodiments of the non-transitory computer-readable storage medium correspond to those of the method for detecting an anomaly based on time information. Thus, description of the storage medium embodiments may refer to that of the method embodiments, and details are not repeated herein.

The embodiments in the specification are described in a progressive manner. Each of the embodiments is mainly focused on describing its differences from other embodiments, and references may be made among these embodiments with respect to the same or similar parts. For the apparatus disclosed in the embodiments, since the apparatus corresponds to the method disclosed in the embodiments, the description thereof is relatively simple. For relate parts, reference may be made to the description of the method.

Those skilled in the art may further realize that the units and algorithm steps of each example described in conjunction with the embodiments disclosed herein can be implemented by electronic hardware, computer software, or a combination of both. To clearly illustrate the interchangeability of hardware and software, the composition and steps of each example are described in general terms of functionality in the above description. Whether these functions are performed by software or hardware depends on the specific application and design constraints of the technical solution. Those skilled in the art may implement the described functions in various manners for each specific application. Such implementations should be considered to be within the scope of the present disclosure.

Steps of the method or algorithm described in the embodiments disclosed herein may be directly implemented by hardware, a software module executable by a processor, or a combination thereof. The software module may be provided in a random access memory (RAM), a memory, a read only memory (ROM), an electrically programmable ROM, an electrically erasable programmable ROM, a register, a hard disk, a removable disk, a CD-ROM or any other forms of storage medium known in the art.

The method and the apparatus for detecting an anomaly based on time information, the electronic device, and the non-transitory computer-readable storage medium according to the present disclosure are described in detail hereinabove. Specific embodiments are used herein to illustrate the principle and implementations of the present disclosure. The description of the above embodiments is only used to facilitate understanding of the method and core concept of the present disclosure. It should be noted that for those skilled in the art, several improvements and modifications may be made without departing from the principle of the present disclosure, and these improvements and modifications also fall within the protection scope of the present disclosure.

1. A method for detecting an anomaly based on time information, comprising:
dividing a preset detection period into a plurality of preset time intervals;
performing different anomaly detection operations on log lines generated by a target system during each of the plurality of preset time intervals to obtain anomaly scores of different detection types corresponding to the preset time interval;
converting the anomaly scores to discrete anomaly scores, adding preset detection type tokens to the discrete anomaly scores to obtain marker token data, and adding a preset timestamp token to a timestamp corresponding to the preset time interval to obtain timestamp token data; and
combining the timestamp token data corresponding to the preset time interval and the marker token data corresponding to the preset time interval to form a token sequence, performing anomaly detection on the token sequence by using a pre-trained detection model to obtain an overall anomaly score of the target system corresponding to the preset time interval, and determining whether the target system is anomalous based on the overall anomaly score, wherein the pre-trained detection model is trained to learn preset baseline token sequences corresponding to the respective preset time intervals, and the overall anomaly score represents a degree of deviation between the token sequence corresponding to the preset time interval and the preset baseline token sequence corresponding to the preset time interval.

2. The method according to claim 1, further comprising:
determining a quantity of the log lines generated by the target system during each of the plurality of preset time intervals, and determining a sampling rate for each of the plurality of preset time intervals based on the quantity;
sampling the log lines generated by the target system during each of the plurality of preset time intervals based on the sampling rate corresponding to the preset time interval,
wherein the performing different anomaly detection operations on log lines generated by a target system during each of the plurality of preset time intervals comprises:
performing different anomaly detection operations on the sampled log lines during each of the plurality of preset time intervals.

3. The method according to claim 1, further comprising:
converting the log lines generated by the target system during each of the plurality of preset time intervals to log token data,
wherein the combining the timestamp token data corresponding to the preset time interval and the marker token data corresponding to the preset time interval to form a token sequence comprises:
combining the timestamp token data corresponding to the preset time interval, the marker token data corresponding to the preset time interval, and the log token data corresponding to the preset time interval to form the token sequence.

4. The method according to claim 1, wherein the performing different anomaly detection operations on log lines generated by a target system during each of the plurality of preset time intervals comprises:
combining the log lines to form a log sequence, and inputting the log sequence into a pre-trained log sequence detection model to obtain an anomaly score of a log sequence detection type, wherein the pre-trained log sequence detection model is trained to learn a preset normal log sequence, and the anomaly score of a log sequence detection type represents a degree of deviation between the log sequence and the normal log sequence;
and/or, updating the log lines to a log parsing tree, and determining a variation degree of the log parsing tree between adjacent pairs of the plurality of preset time intervals to obtain an anomaly score of a log structure detection type;
and/or, determining, based on a preset log field to which each of the log lines belongs, a degree of deviation between an occurrence frequency of the present log field during a current preset time interval and an occurrence frequency of the present log field during a previous preset time interval of the current preset time interval to obtain an anomaly score of a log field detection type;
and/or, extracting a discrete variable value from the log lines, and determining a degree of deviation between an occurrence frequency of each preset value corresponding to the discrete variable value during the current preset time interval and the occurrence frequency of the preset value during the previous preset time interval to obtain an anomaly score of a discrete detection type;
and/or, extracting numerical values from the log lines, clustering the numerical values to obtain a numerical cluster, and determining a degree of deviation between numerical values not belonging to the numerical cluster and the numerical cluster to obtain an anomaly score of a numerical clustering detection type;
and/or, converting a plurality of numerical values of the same type comprised in the log lines into a line chart to obtain a log rate, determining a numerical range for determining an outlier based on the log rate, and determining a ratio of numerical values falling outside the numerical range to all numerical values to obtain an anomaly score of a log rate detection type.

5. The method according to claim 1, wherein the performing anomaly detection on the token sequence by using a pre-trained detection model to obtain an overall anomaly score of the target system corresponding to the preset time interval comprises:
masking a subset of token data in the token sequence to obtain a to-be-processed token sequence, wherein the masked token data in the to-be-processed token sequence comprises the marker token data or a combination of the timestamp token data and the marker token data;
inputting the to-be-processed token sequence into the pre-trained detection model, and predicting, by using the pre-trained detection model, the masked token data in the to-be-processed token sequence based on unmasked token data in the to-be-processed token sequence to obtain predicted token data; and
calculating a loss between the predicted token data and the masked token data by using a preset loss function, and determining the loss as the overall anomaly score.

6. The method according to claim 5, wherein the combining the timestamp token data corresponding to the preset time interval and the marker token data corresponding to the preset time interval to form a token sequence comprises:
combining the timestamp token data corresponding to the preset time interval and the marker token data corresponding to the preset time interval sequentially to form the token sequence, and
wherein the inputting the to-be-processed token sequence into the pre-trained detection model, and predicting, by using the pre-trained detection model, the masked token data in the to-be-processed token sequence based on unmasked token data in the to-be-processed token sequence to obtain predicted token data comprises:
inputting the to-be-processed token sequence into the pre-trained detection model, performing, by using the pre-trained detection model, positional encoding on all token data in the to-be-processed token sequence to obtain an encoding vector, and predicting, by using the pre-trained detection model, the masked token data in the to-be-processed token sequence based on the encoding vector and the unmasked token data in the to-be-processed token sequence to obtain the predicted token data.

7. The method according to claim 5, wherein an overlap exists between adjacent pairs of the plurality of preset time intervals, and
wherein the method further comprises:
inputting the token sequence into the pre-trained detection model, and predicting, by using the pre-trained detection model, a token sequence for a next preset time interval of a current preset time interval based on the token sequence to obtain a predicted token sequence; and
calculating a sequence loss between the predicted token sequence and the token sequence for the next preset time interval by using the preset loss function, and determining whether the target system is anomalous based on the sequence loss.

8. The method according to claim 5, wherein the pre-trained detection model is trained by:
acquiring baseline token sequences for the respective preset time intervals, wherein the baseline token sequence corresponding to each of the plurality of preset time intervals comprises the timestamp token data for the preset time interval;
masking a subset of token data in the baseline token sequence to obtain a to-be-trained token sequence;
inputting the to-be-trained token sequence into an initial detection model, and predicting, by using the initial detection model, the masked token data in the to-be-trained token sequence based on unmasked token data in the to-be-trained token sequence to obtain to-be-compared token data; and
calculating a training loss between the to-be-compared token data and the masked token data in the to-be-trained token sequence by using the preset loss function, and updating a parameter of the initial detection model based on the training loss to obtain the pre-trained detection model.

9. The method according to claim 8, further comprising:
constructing a timestamp vocabulary based on the timestamp token data corresponding to the respective preset time intervals; and
configuring the timestamp vocabulary for the initial detection model, and predicting, by using the initial detection model, masked timestamp token data based on the timestamp vocabulary.

10. An apparatus for detecting an anomaly based on time information, comprising:
a time division module, configured to divide a preset detection period into a plurality of preset time intervals;
a detection module, configured to perform different anomaly detection operations on log lines generated by a target system during each of the plurality of preset time intervals to obtain anomaly scores of different detection types corresponding to the preset time interval;
a token generation module, configured to convert the anomaly scores to discrete anomaly scores, add preset detection type tokens to the discrete anomaly scores to obtain marker token data, and add a preset timestamp token to a timestamp corresponding to the preset time interval to obtain timestamp token data; and
a model detection module, configured to combine the timestamp token data corresponding to the preset time interval and the marker token data corresponding to the preset time interval to form a token sequence, perform anomaly detection on the token sequence by using a pre-trained detection model to obtain an overall anomaly score of the target system corresponding to the preset time interval, and determine whether the target system is anomalous based on the overall anomaly score, wherein the pre-trained detection model is trained to learn preset baseline token sequences corresponding to the respective preset time intervals, and the overall anomaly score represents a degree of deviation between the token sequence corresponding to the preset time interval and the preset baseline token sequence corresponding to the preset time interval.

11. An electronic device, comprising:
a memory; and
a processor, wherein the memory is configured to store a computer program, and the processor is configured to execute the computer program to implement the method for detecting an anomaly based on time information according to claim 1.

12. A non-transitory computer-readable storage medium, storing a computer-executable instruction, wherein the computer-executable instruction is loaded and executed by a processor to implement the method for detecting an anomaly based on time information according to claim 1.
